(19) United States
(12) Patent Application Publication
(10) Pub. No.: US 2014/0181772 A1
(43) Pub. Date: Jun. 26, 2014

(54) DETERMINING HIGH QUALITY INITIAL CANDIDATE SINK LOCATIONS FOR ROBUST CLOCK NETWORK DESIGN

(71) Applicant: INTERNATIONAL BUSINESS MACHINES CORPORATION, Armonk, NY (US)

(72) Inventors: Charles Jay Alpert, Austin, TX (US); Zhuo Li, Cedar Park, TX (US); Chin Ngai Sze, Austin, TX (US); Ying Zhou, Austin, TX (US)

(73) Assignee: INTERNATIONAL BUSINESS MACHINES CORPORATION, Armonk, NY (US)

(21) Appl. No.: 13/724,212

(22) Filed: Dec. 21, 2012

(51) Int. Cl. G06F 17/50

(52) U.S. Cl. CPC G06F 17/5068
USPC 716/114; 716/134

(57) ABSTRACT

A design tool with an initial sink locator unit determines a number of clock buffers for driving clock signals to loads in a clock distribution network. The design tool determines clusters of loads in the clock distribution network, wherein the number of clusters is equal to the number of clock buffers and the loads are uniformly distributed amongst the clusters. The design tool determines centers of the clusters as initial candidate sink locations for the clock buffers. The design tool iteratively determines new clusters and determines centers of the new clusters as optimized initial candidate sink locations.

### BACKGROUND

Embodiments of the inventive subject matter generally relate to the field of computers, and, more particularly, to determining high quality initial candidate sink locations for a robust clock network design.

High-performance very large scale integration (VLSI) chips have an internal clock signal that is a function of an external clock signal. The internal clock signal (hereinafter “clock signal”) is distributed to a large number of clock pins. The clock pins are specific locations or metal shapes on a VLSI chip (hereinafter “chip”) which have a known or estimated effective pin capacitance.

Clock buffers drive the clock signal in a clock distribution network. Clock skew is the difference in arrival time of the clock signal at different locations in the chip. Clock skew can limit achievable cycle time and reduce chip performance. Clock slew is the rate of change of the clock signal voltage. The output terminal of a clock buffer may be connected at one of the multiple locations in the clock distribution network. The locations at which the output terminals of the clock buffers are connected, are referred to as sink locations. The sink location impacts on the final clock skew.

### SUMMARY

Embodiments of the inventive subject matter include a method that determines, within a clock distribution network for a microprocessor, a number of clock buffers for driving clock signals to loads in the clock distribution network. The method determines clusters of loads in the clock distribution network, wherein the number of clusters is equal to the number of clock buffers and the loads are uniformly distributed amongst the clusters. The method determines centers of the clusters as initial candidate sink locations for the clock buffers. The method iteratively determines new clusters and determine centers of the new clusters as optimized initial candidate sink locations.

### BRIEF DESCRIPTION OF THE DRAWINGS

The present embodiments may be better understood, and numerous objects, features, and advantages made apparent to those skilled in the art by referencing the accompanying drawings.

FIG. 1A depicts an example conceptual diagram of a clock distribution network with sectors shorted together to form the clock distribution network.

FIG. 1B depicts an example conceptual diagram of a design tool with an initial sink locator unit to determine high quality initial candidate sink locations in a section of a clock distribution network.

FIG. 2 illustrates a flow diagram of example operations to determine high quality initial candidate sink locations in a clock distribution network.

FIG. 3 illustrates a flow diagram of example to determine clusters of loads having a uniform load distribution using a top-down bi-partitioning technique.

FIG. 4 illustrates a flow diagram of example operations to determine clusters of loads having a uniform size.

FIG. 5 illustrates a flow diagram of example operations to determine clusters of loads having a uniform load distribution using a bottom-up clustering technique.

FIG. 6 illustrates a flow diagram of example operations to determine clusters of loads having a uniform load distribution using the metric k-center technique.

FIG. 7 illustrates a flow diagram of example operations to determine clusters of loads having a uniform load distribution using the k-means clustering technique.

FIG. 8 depicts an example computer system with an initial sink locator unit.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. For instance, initial candidate sink locations for clock buffers in a clock distribution network may be determined by one or more units in a circuit design tool or the system memory. In other instances, well-known instruction instances, protocols, structures and techniques have not been shown in detail in order not to obfuscate the description.

Various techniques may be utilized to optimally determine sink locations for clock buffers. However, such techniques starting from an initial set of candidate sink locations. Performance of such techniques may not be optimum when the initial candidate sink locations are not of high quality (e.g., loads driven through the initial candidate sink locations are poorly distributed amongst the initial candidate sink locations). An initial sink locator unit can determine initial candidate sink locations for one or more of such techniques. For example, the initial sink locator unit can determine clusters of loads in a clock distribution network. The initial sink locator unit determines a number of clusters equal to the number of clock buffers to be connected in the clock distribution network. The initial sink locator unit then determines the center of clusters as initial candidate sink locations for clock buffers. The initial sink locator can optimize the initial candidate sink locations by further fine-tuning the clusters and finding the centers of clusters.

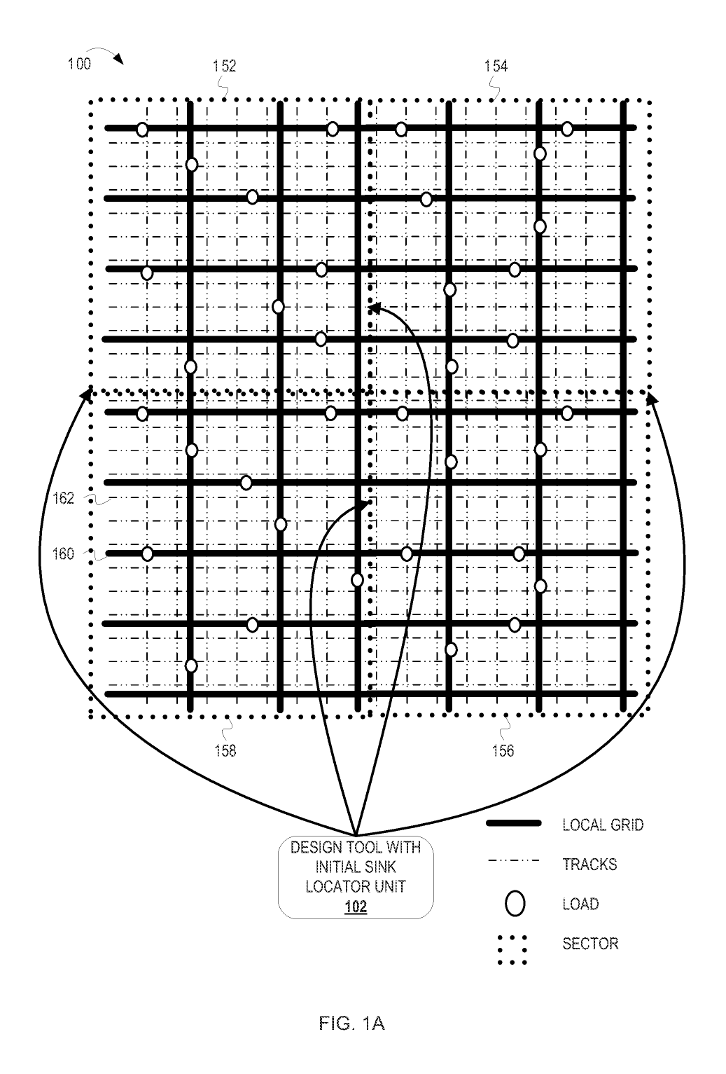

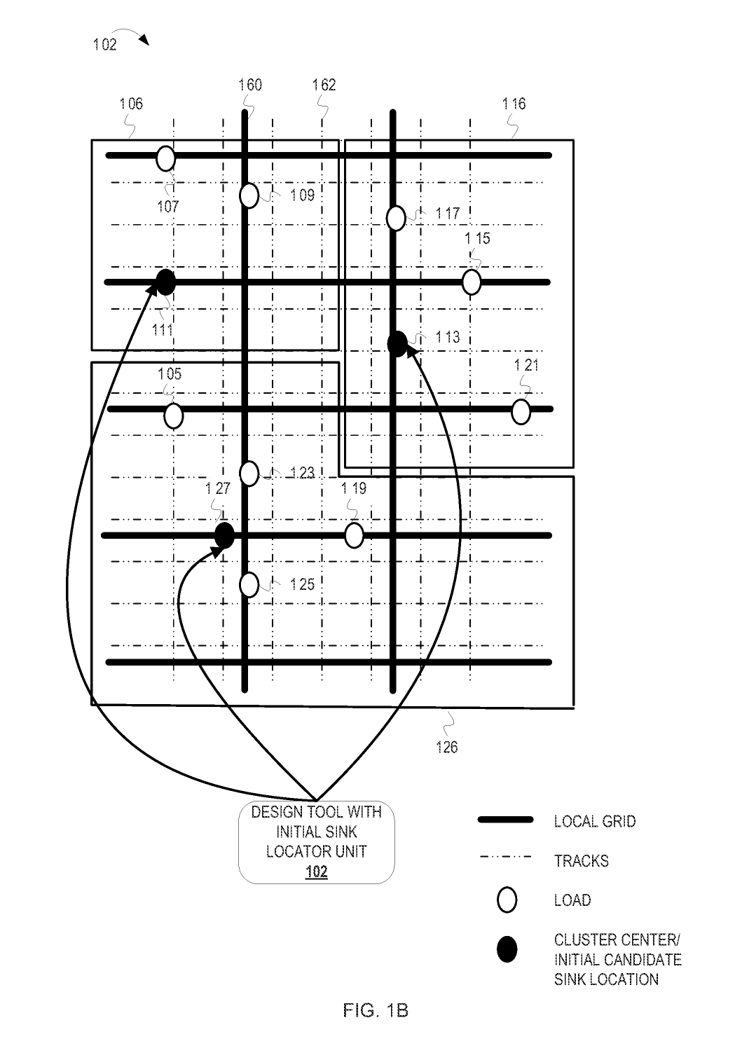

FIG. 1A depicts an example conceptual diagram of a clock distribution network with sectors shorted together to form the clock distribution network. FIG. 1A depicts a clock distribution network 100. The clock distribution network 100 is typically divided into sectors for certain operations (e.g., simulation, analysis, etc.) in the clock distribution network 100. The sectors have smaller area as compared to the clock distribution network 100 which allow savings in simulation time and tuning time of the clock distribution network 100. The clock distribution network 100 includes four sectors 152, 154, 156 and 158. It is noted that the clock distribution network 100 in FIG. 1 includes four sectors only for the purpose of illustration. However, the clock distribution network 100 may include hundreds of sectors. The clock distribution network 100 also includes a local grid 160 (represented by the thickest gridlines) and tracks 162 (represented by the dashed gridlines). The local grid 160 may alternatively consist of vertical or horizontal clock spines, any other wiring structure or structures that collectively connect loads in the clock distribution network 100. Clock signals can be sent from the output of clock buffers to the local grid 160 over the tracks 162. The local grid 160 includes loads which are typically capacitive loads in the clock distribution network 100. The local grid 160 can distribute the clock signals and also supply the clock signals to drive the downstream load (i.e., the load on the chip).

Clock buffers drive clock signals to the loads in the clock distribution network 100. The clock buffers may not be located close to the clock distribution network 100, however the output terminals of the clock buffers are connected to sink locations in the clock distribution network 100 in order to drive the clock signals. The number of clock buffers for the clock distribution network 100 may be determined based on loads in each of the sectors 152, 154, 160 and 162. For example, total load in the sector 152 can be computed and number of clock buffers to drive the loads in the sector 152 can be determined. Once, the number of clock buffers is determined, initial candidate sink locations for connecting clock buffers in the sector 152 may be determined. However, determining the number of clock buffers to drive loads in each of the sectors may not always be efficient. For example, when the total load in the sector 152 is 200 pico farad (pF), the total load in the sector 154 is 150 pF, and the amount of load a clock buffer can drive is 60 pF. The total number of clock buffers to drive the load in the sectors 152 and 154 would be 7 (4 clock buffers for the sector 152 and 3 clock buffers for the sector 154). However, when the number of clock buffers to drive total load over a larger area (e.g., the sectors 152 and 154 shorted together) is determined, the number of clock buffers to drive the total load in the sectors 152 and 154 would be 6. Hence, it may be more efficient to determine clock buffers and initial candidate sink locations over a larger area. A design tool 102 with an initial sink locator unit can determine clock buffers and initial candidate sink locations for the clock distribution network 100 over the full chip. The design tool 102 shorts the sectors 152, 154, 156 and 160 (by merging the sector boundaries) as depicted in FIG. 1A to determine clock buffers and initial candidate sink locations for the clock distribution network 100 over the full chip.

FIG. 1B depicts an example conceptual diagram of a design tool with an initial sink locator unit to determine high quality initial candidate sink locations in a section of a clock distribution network. FIG. 1B includes a section 102 of the clock distribution network, and a design tool 102 with an initial sink locator unit. The design tool 102 determines clusters of loads to be driven by each of the clock buffers (i.e., the clock buffers determined based on the total load to be driven in the section 102). The design tool 102 also determines initial candidate sink locations for the clock buffers in the section 102 as the centers of the clusters. FIG. 1B depicts the design tool 102 determining the clusters and the initial candidate sink locations in the section 102 only for the purpose of illustration. It is noted that the design tool 102 determines the clusters and initial candidate sink locations in the clock distribution network over the full chip at the same time. The section 102 includes a local grid 160 (represented by the thickest gridlines) and available tracks 162 (represented by the dashed gridlines). The clock signals are transmitted over the local grid 160. Signals are transmitted from the output of clock buffers to the local grid 160 over the tracks 162.

The local grid 160 includes loads 105, 107, 109, 115, 117, 119, 121, 123, and 125. The loads on the local grid 160 are typically capacitive loads due to high fan-out of logic gates. The section 102 includes clusters of loads 106, 116, and 126 which are determined by the design tool 102. The cluster 106 includes the loads 107 and 109. The cluster 116 includes the loads 115, 117 and 119. The cluster 126 includes the loads 105, 119, 123, and 127. The design tool 102 determines the clusters such that the loads in the section 102 are uniformly distributed amongst the clusters 106, 116, and 126. The design tool 102 further determines a center 111 of the cluster 106, a center 113 of the cluster 116, and a center 127 of the cluster 126, respectively. The design tool 102 determines a center of a cluster such that the sum of distances to the loads in the cluster from the center is the least. The distance measured by the design tool 102 in determining distances to the loads is the distance on the local grid 160.

After determining the clusters 106, 116, and 126 and their respective centers 111, 113, and 127, the design tool 102 performs one or more iterations to fine tune the clusters 106, 116 and 126. For example, the design tool 102 can start from the centers 111, 113, and 127 to determine new clusters by associating loads with the centers 111, 113, and 127, respectively. The design tool 102 can then determine new centers for the new clusters. The clusters determined by the design tool 102 in second or subsequent iterations may include different loads then the loads included in the clusters 106, 116, and 126. For example, in the second or subsequent iterations, the load 105 may be a part of a cluster which includes loads 107 and 109 rather than the cluster which includes loads 123, 125, and 129.

The design tool 102 can utilize one or more techniques to determine clusters in the section 102. In a first technique, the design tool 102 can determine the clusters in the section 102 by utilizing a top-down bi-partitioning technique. In the top-down bi-partitioning technique, the design tool 102 divides the section 102 into two clusters having similar amount of loads. The design tool 102 then divides each of the two clusters into smaller clusters of similar amount of loads. The design tool then divides each of the smaller clusters into further smaller clusters. The design tool 102 continues to divide clusters until the number of clusters is equal to the number of clock buffers to be utilized for driving clock signals in the section 102.

In a second technique, the design tool 102 determines clusters in the section 102 such that the clusters are of geometrically similar sizes. For example, the design tool 100 determines the total area of the section 102, and then determines the area for each cluster by dividing the total area by the number of clock buffers to determine area of each cluster. The design tool 102 can then determine clusters based on the area of each cluster. In some embodiments, the design tool 102 divides the section 102 into smaller sections (equal to the number of clock buffers) of equal area. The design tool 102 then determines the center point of the section and associates loads with the center points to form clusters.

In a third technique, the design tool 102 determines clusters of loads using a bottom-up clustering technique. In the bottom-up clustering technique, the design tool 102 determines non-uniform load points in the section 102. For example, the design tool 102 determines load points which have loads in their neighborhood on the next level of clock distribution network. The design tool 102 determines M number of non-uniform load points in the section 102 and then forms M clusters around the M non-uniform load points. The design tool 102 then merges the M clusters to form N clusters (where N is the number of clock buffers to drive clock signals into the section 102) with uniform load distribution.

In a fourth technique, the design tool 102 determines M non-uniform load points in the section 102. The design tool 102 then determines N points using the metric k-center technique. The design tool 102 utilizes the metric k-center technique to determine N points from the M points such that maximum distance from each of M points to a corresponding point in the N points is minimized. The design tool 102 then determines N clusters around the N points. For example, the design tool 102 associates loads in the section 102 with N points to form N clusters.

In a fifth technique, the design tool 102 determines M non-uniform load points in the section 102. The design tool 102 then utilizes the k-means clustering technique to determine N clusters of loads in the section 102. For example, the design tool 102 determines N points as initial means and associates loads with the N-points to form N clusters. The design tool 102 determines centroids of each of the N clusters. The design tool 102 repeats the association of loads and determination of centroid steps by starting with centroids of the N clusters as initial means. The design tool 102 may repeat these steps until convergence in the k-means clustering technique (i.e., uniform distribution of loads amongst the N clusters) is achieved.

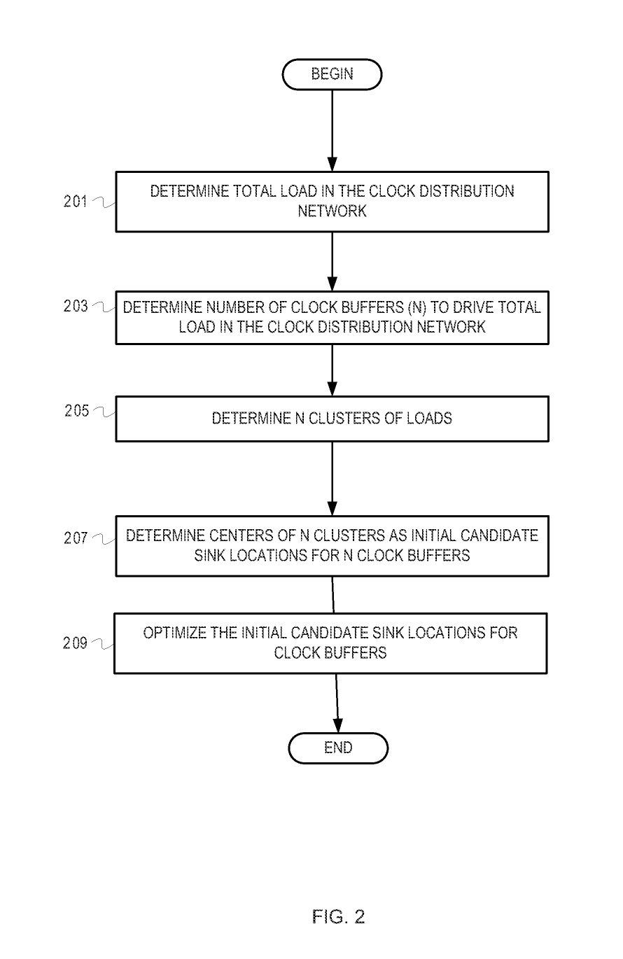

FIG. 2 illustrates a flow diagram of example operations to determine high quality initial candidate sink locations in a clock distribution network.

At block 201, total load in the clock distribution network is determined. For example, an initial sink locator unit determines the total load to be driven by clock buffers in the clock distribution network. The initial sink locator determines a sum of all load capacitances in the clock distribution network.

At block 203, a number of clock buffers (N) to drive the total load is determined. For example, the initial sink locator unit determines the number of clock buffers (N) to drive the total load in the clock distribution network. The initial sink locator unit determines the number of clock buffers (N) based on the capacity of a clock buffer (i.e., the amount of load a clock buffer can drive). For example, the initial sink locator unit determines the number of clock buffers (N) by dividing the total load in the clock distribution network with the amount of load a clock buffer can drive.

At block 205, N clusters of loads are determined. For example, the initial sink locator unit determines the N clusters of loads in the clock distribution network. The initial sink locator unit can determine the N clusters using one of the techniques (e.g., a top-down bi-partitioning technique, a bottom-up clustering technique, clustering based on geometric symmetry, the metric k-center technique, the k-means clustering technique, etc.). The operations for each of the five techniques are described below in flow diagrams 3-7. The initial sink locator unit performs the operations at block 203 using one of the sequences of operations described in flow diagrams 3-7.

At block 207, centers of N clusters are determined as initial candidate sink locations for N clock buffers. For example, the initial sink locator unit determines a center of each of the N clusters such that distances on a local grid from the center of the cluster to the loads in the cluster are minimized. The initial sink locator unit can perform one or more iterations to select a point in the cluster which lies at the intersection of the local grid and routing tracks, and from which distances to the loads in the cluster are minimized.

At block 209, initial candidate sink locations for clock buffers are optimized. For example, the initial sink locator unit can determine new clusters starting with the initial candidate sink locations (determined at block 207). The initial sink locator unit can associate loads with the initial candidate sink locations (determined at block 207) and form new clusters. The initial sink locator unit can then find centers of new clusters as optimized initial candidate sink locations. The initial sink locator can repeat the operations of forming clusters and determining centers of clusters multiple times to optimize the initial candidate sink locations for clock buffers in the clock distribution network.

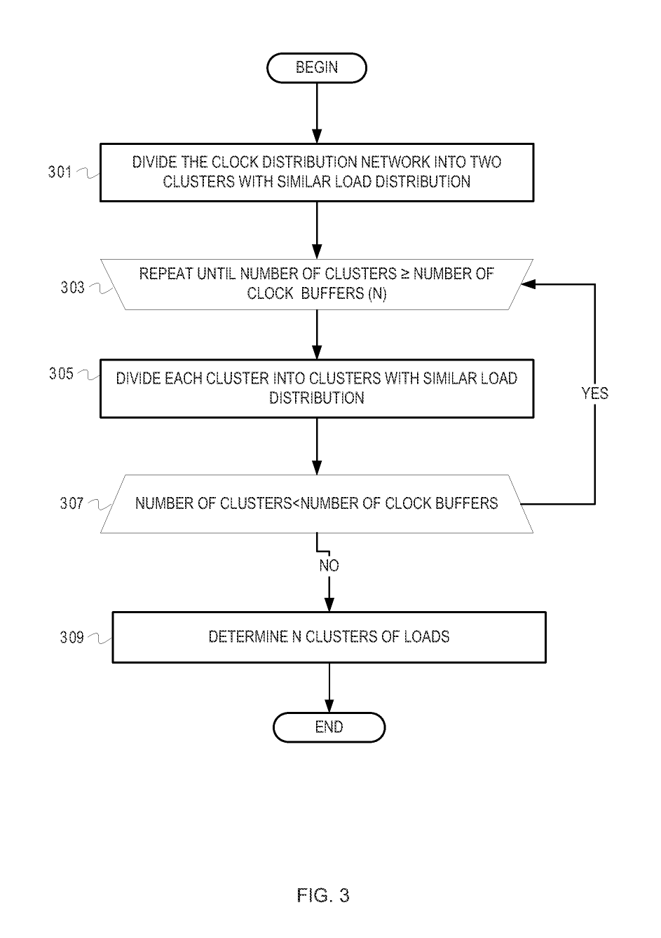

FIG. 3 illustrates a flow diagram of example to determine clusters of loads having a uniform load distribution using a top-down bi-partitioning technique.

At block 301, a clock distribution network is divided into two clusters with similar load distribution. For example, an initial sink locator unit divides the clock distribution network into two clusters by partitioning it horizontally such that each cluster has a similar amount of load. In some embodiments, the initial sink locator unit divides the clock distribution network into two clusters by partitioning it vertically such that each cluster has a similar amount of load. It is noted that ideally the initial sink locator divides the clock distribution network into two clusters having an equal amount of load. However, since loads in the clock distribution network are concentrated at specific points, the initial sink locator unit divides the clock distribution network into two clusters having similar (or almost equal) amount of load.

At block 303, a loop is started and the operations in the loop are repeated until a number of clusters is greater than or equal to a number of clock buffers (N). The loop includes operations at blocks 305 and 307. For example, the initial sink locator unit starts a loop and the operations in the loop are repeated until the number of clusters created after completion of an iteration of the loop are greater than or equal to a predetermined number of clock buffers (N).

At block 305, each cluster is divided into clusters with similar load distribution. For example, the initial sink locator unit divides each cluster (created in the previous iteration of the loop) into two clusters with similar load distribution. In the first iteration of the loop, the initial sink locator unit divides the two clusters created at block 301 into four clusters. In some embodiments, the initial sink locator divides a cluster into two clusters having similar load distribution by partitioning the cluster horizontally. In other embodiments, the initial sink locator unit divides a cluster into two clusters having similar load distribution by partitioning the cluster vertically.

At block 307, it is determined whether the number of clusters is smaller than the number of clock buffers. For example, the initial sink locator unit determines whether the number of clusters created after the current iteration of the loop is smaller than the number of clock buffers (N). If the number of clusters is smaller than the number of clock buffers, control flows to block 303. If the number of clusters is not smaller than the number of clock buffers, control flows to block 309.

At block 309, N clusters of loads are determined. For example, the initial sink locator unit determines N clusters of loads when the control exits the loop started at block 303. In some embodiments, when the control exits the loop the number of clusters is equal to N, and the initial sink locator unit determines the N clusters of loads. In other embodiments, when the control exits the loop, the number of clusters is greater than N. When the number of clusters is greater than N, the initial sink locator unit may merge certain clusters such that the number of clusters is equal to N. The initial sink locator unit can merge the clusters such that loads amongst the clusters formed after merging are uniformly distributed.

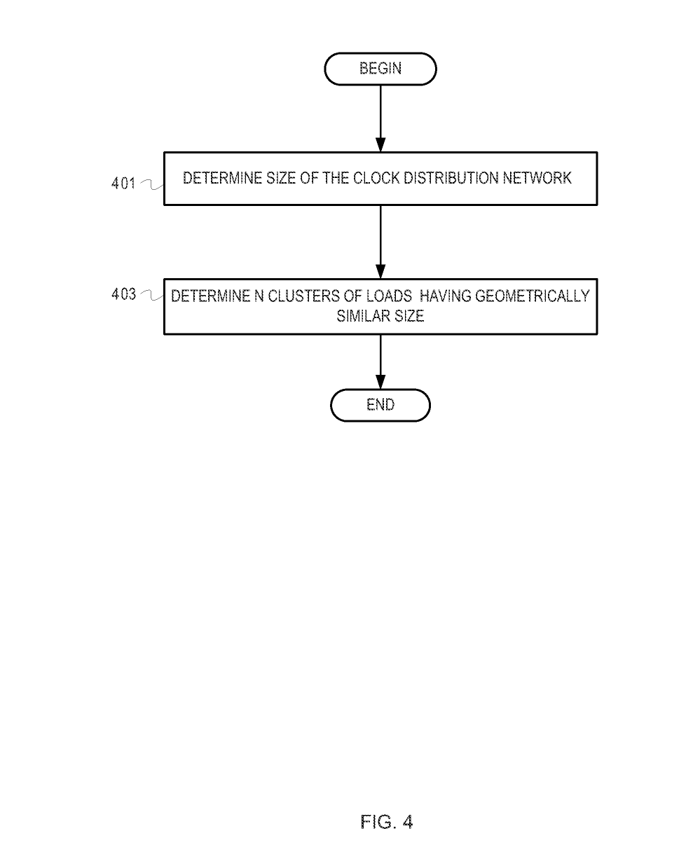

FIG. 4 illustrates a flow diagram of example operations to determine clusters of loads having a uniform size.

At block 401, a size of a clock distribution network is determined. For example, the initial sink locator unit determines the area of the clock distribution network. The initial sink locator unit can determine the area of the clock distribution network by utilizing dimensions of the clock distribution network available in a design tool or in the system memory.

At block 403, N clusters of loads are determined having geometrically similar size. For example, the initial sink locator unit determines the area of each cluster by dividing the total area of the clock distribution network with a predetermined number of clock buffers (N). The initial sink locator unit then determines clusters having geometrically similar sizes by placing a virtual grid on the top of the clock distribution network. The area of each cell in the grid is equal to the area of a cluster determined by the initial sink locator unit. The initial sink locator unit can then determine the geometric center of each cell and associate neighboring loads in the cell with the center to form N clusters.

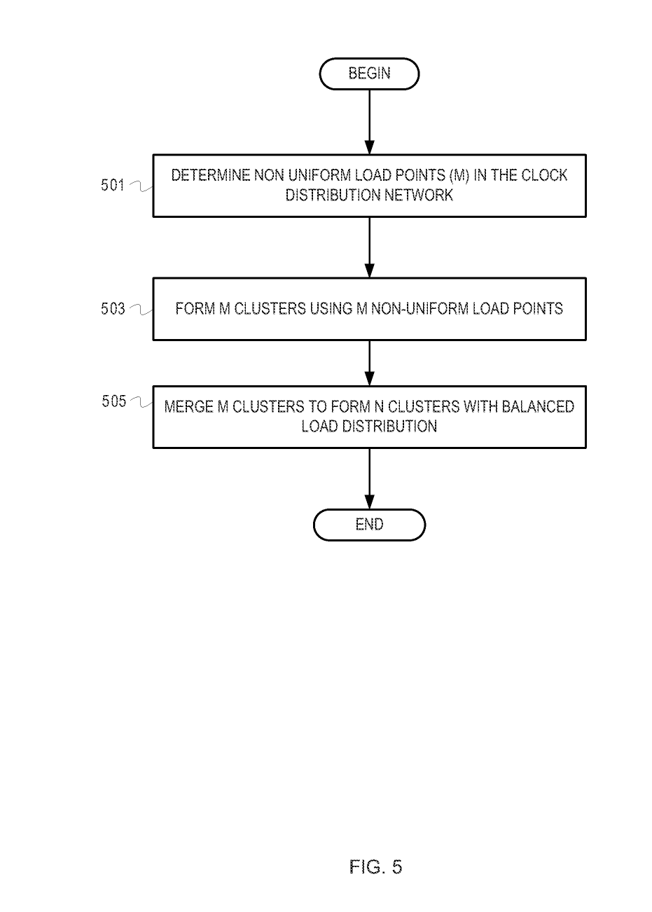

FIG. 5 illustrates a flow diagram of example operations to determine clusters of loads having a uniform load distribution using a bottom-up clustering technique.

At block 501, non-uniform load points in a clock distribution network are determined. For example, the initial sink locator unit determines non-uniform load points in the clock distribution network. A non-uniform load point is a point in the clock distribution network which has one or more loads in its neighborhood on the next level of the clock distribution network. The initial sink locator unit determines M number of non-uniform load points in the clock distribution network.

At block 503, M clusters are formed using M non-uniform load points. For example, the initial sink locator unit associates loads in the neighborhood of the M non-uniform load points to the M points to form M-clusters. The initial sink locator unit associates loads to form M clusters such that loads are evenly distributed in the neighboring clusters.

At block 505, M clusters are merged to form N clusters with a balanced load distribution. For example, the initial sink locator unit merges M clusters to form N clusters (where N is a predetermined number and equal to the number of clock buffers to drive clock signals to the clock distribution network). In some embodiments, the initial sink locator unit merges M clusters in multiple steps. For example, the initial sink locator unit merges the M clusters taking two clusters at a time, and repeats merging until N clusters are obtained. The initial sink locator unit merges the clusters such that in each step of merging, loads in the neighboring clusters are uniformly distributed.

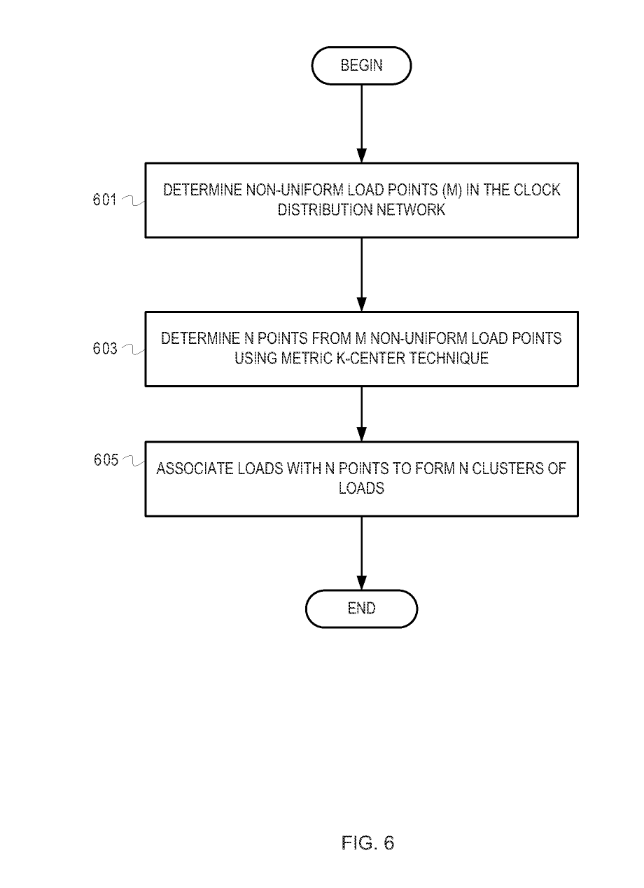

FIG. 6 illustrates a flow diagram of example operations to determine clusters of loads having a uniform load distribution using the metric k-center technique.

At block 601, non-uniform load points in a clock distribution network are determined. For example, the initial sink locator unit determines non-uniform load points in the clock distribution network. A non-uniform load point is a point in the clock distribution network which has one or more loads in its neighborhood on the next level of the clock distribution network. The initial sink locator unit determines M number of non-uniform load points in the clock distribution network.

At block 603, N points from M non-uniform load points are determined using the metric k-center technique. The initial sink locator unit utilizes the metric k-center technique to determine N points (where N is a pre-determined number of clock buffers), from M non-uniform load points such that the maximum distance from the M points to the N points is minimized. Determining N points from M points is similar to finding a set of N vertices for which the largest distance of any point (from the M points) to its closest vertex is minimum. The distance minimized by the initial sink locator unit is the distance on a local grid of the clock distribution network. Minimizing the distance is equivalent to minimizing the length of connecting wires from an initial candidate sink location to a load point, which allows minimizing the delay for clock signals (since delay is directly proportional to length of connecting wire).

At block 605, loads are associated with N points to form N clusters of loads. For example, the initial sink locator unit associates loads to the N points determined at block 603. The initial sink locator unit associates loads to the N-points to form clusters such that loads in the neighboring clusters are evenly distributed.

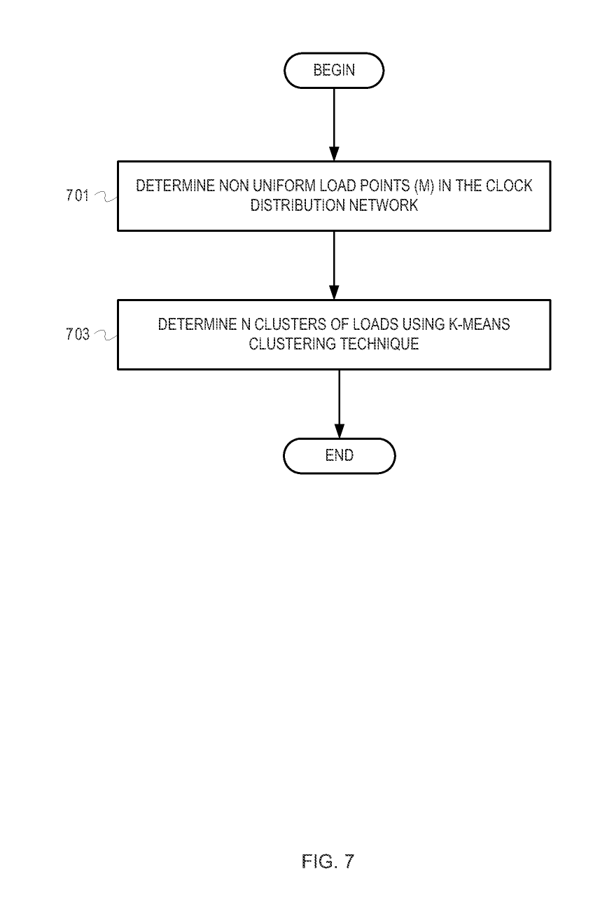

FIG. 7 illustrates a flow diagram of example operations to determine clusters of loads having a uniform load distribution using the k-means clustering technique.

At block 701, non-uniform load points in a clock distribution network are determined. For example, the initial sink locator unit determines non-uniform load points in the clock distribution network. A non-uniform load point is a point in the clock distribution network which has one or more loads in its neighborhood on the next level of the clock distribution network. The initial sink locator unit determines M number of non-uniform load points in the clock distribution network.

At block 703, N clusters of loads are determined using the k-means clustering technique. For example, the initial sink locator unit determines N clusters of loads (where N is a predetermined number of clock buffers for driving clock signals into the clock distribution network) using the k-means clustering technique such that each non-uniform load point belongs to a cluster with the nearest mean (i.e., the nearest average value). The initial sink locator unit determines N initial means for the k-means clustering technique. In some embodiments, the initial sink locator unit may randomly generate the N initial means. The initial sink locator unit then creates N clusters around the N initial means by associating M non-uniform load points nearest to their respective means. The initial sink locator unit can also associate neighboring loads to each of the N clusters. The initial sink locator unit determines the centroid of each of the N clusters and utilizes the centroids as new means for creating new clusters. In some embodiments, the initial sink locator unit repeats determination of new means and creation of new clusters, until distribution of loads in the clusters are balanced within a specified range.

It is noted that the initial sink locator unit may utilize any of the operations described in the flow diagrams 3-7 to determine a number of clusters which are equal to the number of clock buffers to be utilized in the clock distribution network. In some embodiments, the initial sink locator unit may utilize more than one of the techniques described in the flow diagrams 3-7 to determine N clusters. The initial sink locator unit can then utilize the N clusters obtained from one of the techniques for determining initial candidate sink locations. For example, the initial sink locator unit can utilize the N clusters which have the most even load distribution amongst the N clusters. The initial sink locator unit can then determine center of the chosen N clusters as the initial candidate sink locations for clock buffers.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

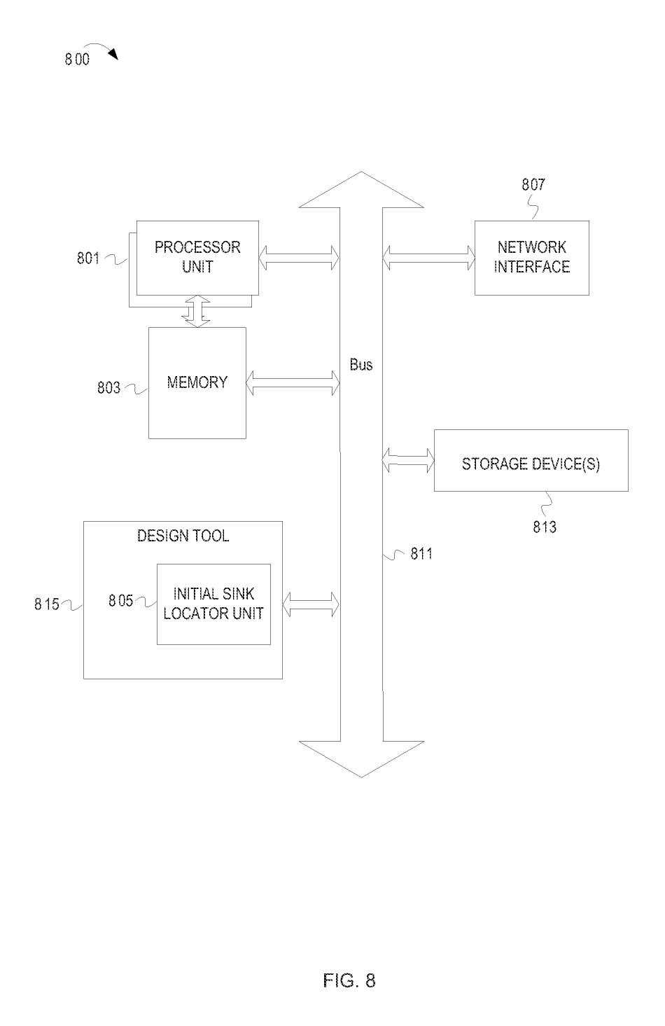

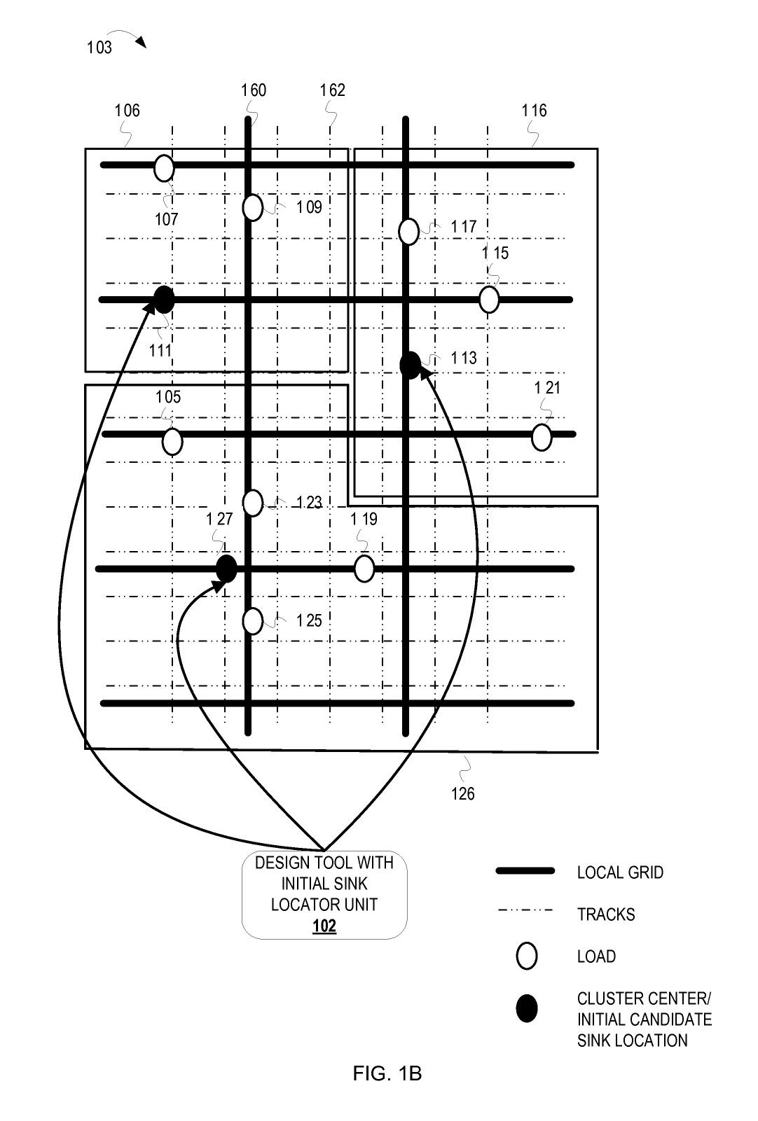

FIG. 8 depicts an example computer system with an initial sink locator unit. The computer system 800 includes a processor unit 801 (possibly including multiple processors, multiple cores, multiple nodes, and/or implementing multi-threading, etc.). The computer system includes memory 803. The memory 803 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 811 (e.g., PCI, ISA, PCI-Express, HyperTransport®, InfiniBand®, NuBus, etc.), a network interface 807 (e.g., an ATM interface, an Ethernet interface, a Frame Relay interface, SONET interface, wireless interface, etc.), a storage device(s) 813 (e.g., optical storage, magnetic storage, etc.) and an initial sink locator unit 805 embodied in a design tool 815. The initial sink locator unit 805 embodies functionality to aid the design tool 815 in determining high quality initial candidate sink locations for clock buffers in a clock distribution network. The high quality initial candidate sink locations for the clock buffers can be utilized by the design tool 815 in one or more techniques for determining sink locations for the clock buffers in the clock distribution network. The design tool 815 can determine sink locations for clock buffers using the high quality initial candidate sink locations such that loads in the clock distribution network are balanced amongst the sink locations. Balancing the loads amongst the sink locations can reduce the clock skew in the clock distribution network. The initial sink locator unit 805 determines the number of clock buffers to drive the total load in the clock distribution network. The initial sink locator unit 805 then determines clusters of loads (i.e., the loads in the clock distribution network) using one or more techniques such that loads in the clusters are evenly distributed. The initial sink locator unit 805 determines initial candidate sink locations as centers of the clusters. Any one of these functionalities may be partially (or entirely) implemented in hardware and/or on the processing unit 801. For example, the functionality may be implemented with an application specific integrated circuit, in logic implemented in the processing unit 801, in a co-processor on a peripheral device or card, etc. The design tool 815 may be an independent unit as depicted or a component of a circuit design program. The design tool 815 may be program code embodied in the memory 803. Further, realizations may include fewer or additional components not illustrated in FIG. 8 (e.g., video cards, audio cards, additional network interfaces, peripheral devices, etc.). The processor unit 801, the storage device(s) 813, the network interface 807 and the design tool 815 are coupled to the bus 811. Although illustrated as being coupled to the bus 811, the memory 803 may be coupled to the processor unit 801.

While the embodiments are described with reference to various implementations and exploitations, it will be understood that these embodiments are illustrative and that the scope of the inventive subject matter is not limited to them. In general, techniques for determining high quality initial candidate sink locations for clock buffers in a clock distribution network as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method comprising:
determining, by a machine, a number of clock buffers for driving clock signals to loads in a clock distribution network for a microprocessor design;
determining clusters of loads in the clock distribution network, wherein the number of clusters is equal to the number of clock buffers and the loads are uniformly distributed amongst the clusters;
determining centers of the clusters as initial candidate sink locations for the clock buffers; and
determining new clusters of the loads based on the initial candidate sink locations for the clock buffers; and
determining centers of the new clusters of the loads as optimized initial candidate sink locations for the clock buffers.

2. The method of claim 1, wherein said determining the number of clock buffers comprises:
determining total load in the clock distribution network; and
determining the number of clock buffers to drive the total load based on the amount of load a clock buffer can drive.

3. The method of claim 1, wherein said determining the clusters of loads comprises:
dividing the clock distribution network into two clusters with similar load distribution;
repeatedly dividing each of the two clusters into clusters with similar load distribution until the number of clusters is greater than or equal to the number of clock buffers; and
determining the number of clusters equal to the number of clock buffers.

4. The method of claim 3, wherein said determining the number of clusters equal to the number of clock buffers comprises merging the clusters to form the number of clusters equal to the number of clock buffers when the number of clusters is greater than the number of clock buffers.

5. The method of claim 1, wherein said determining the clusters of loads comprises:
determining a size of the clock distribution network; and
determining clusters having geometrically similar sizes.

6. The method of claim 1, wherein said determining the clusters of loads comprises:
determining non-uniform load points in the clock distribution network, wherein a non-uniform load point is a point in the clock distribution network which has one or more loads in its neighborhood on a next level of the clock distribution network;
forming a number of clusters equal to the number of non-uniform load points; and
merging the clusters to form a number of clusters equal to the number of clock buffers.

7. The method of claim 1, wherein said determining the clusters of loads comprises:
determining non-uniform load points in the clock distribution network, wherein a non-uniform load point is a point in the clock distribution network which has one or more loads in its neighborhood on a next level of the clock distribution network;
determining a number of points equal to the number of clock buffers from the non-uniform load points using the metric k-center technique; and
associating loads with the points to form a number of clusters equal to the number of clock buffers.

8. The method of claim 1, wherein said determining the clusters of loads comprises:
determining non-uniform load points in the clock distribution network, wherein a non-uniform load point is a point in the clock distribution network which has one or more loads in its neighborhood on a next level of the clock distribution network; and
determining a number of clusters equal to the number of clock buffers using the k-means clustering technique.

9. The method of claim 1, wherein said determining the new clusters comprises associating loads with the initial candidate sink locations to form the new clusters.

10. A computer program product for clock network design, the computer program product comprising:
a computer readable storage medium having computer usable program code embodied therewith, the computer usable program code comprising a computer usable program code configured to:
determine, a number of clock buffers for driving clock signals to loads of a clock distribution network design of a microprocessor design;
determine clusters of loads in the clock distribution network sign, wherein the number of clusters is equal to the number of clock buffers and the loads are uniformly distributed amongst the clusters;
determine centers of the clusters as initial candidate sink locations for the clock buffers; and
determine new clusters of the loads based on the initial candidate sink locations for the clock buffers; and
determine centers of the new clusters as optimized initial candidate sink locations for the clock buffers.

11. The computer program product of claim 10, wherein the computer usable program code configured to determine the clusters of loads comprises the computer usable program code configured to:
divide the clock distribution network into two clusters with similar load distribution;
repeatedly divide each of the two clusters into clusters with similar load distribution until the number of clusters is greater than or equal to the number of clock buffers; and
determine the number of clusters equal to the number of clock buffers.

12. The computer program product of claim 10, wherein the computer usable program code configured to determine the clusters of loads comprises the computer usable program code configured to:
determining a size of the clock distribution network; and
determining clusters having geometrically similar sizes.

13. The computer program product of claim 10, wherein the computer usable program code configured to determine the clusters of loads comprises the computer usable program code configured to:
determine non-uniform load points in the clock distribution network, wherein a non-uniform load point is a point in the clock distribution network which has one or more loads in its neighborhood on a next level of the clock distribution network;
form a number of clusters equal to the number of non-uniform load points; and
merge the clusters to form a number of clusters equal to the number of clock buffers.

14. The computer program product of claim 10, wherein the computer usable program code configured to determine the clusters of loads comprises the computer usable program code configured to:
determine non-uniform load points in the clock distribution network, wherein a non-uniform load point is a point in the clock distribution network which has one or more loads in its neighborhood on a next level of the clock distribution network;
determine a number of points equal to the number of clock buffers from the non-uniform load points using the metric k-center technique; and
associate loads with the points to form a number of clusters equal to the number of clock buffers.

15. The computer program product of claim 10, wherein the computer usable program code configured to determine the clusters of loads comprises the computer usable program code configured to:
determine non-uniform load points in the clock distribution network, wherein a non-uniform load point is a point in the clock distribution network which has one or more loads in its neighborhood on a next level of the clock distribution network; and
determine a number of clusters equal to the number of clock buffers using the k-means clustering technique.

16. An apparatus comprising:
a processor,
a bus; and
a computer readable storage medium having computer usable program code embodied therewith, the computer usable program code comprising a computer usable program code configured to:
determine, a number of clock buffers for driving clock signals to loads of a clock distribution network of a microprocessor design;
determine clusters of loads in the clock distribution network, wherein the number of clusters is equal to the number of clock buffers and the loads are uniformly distributed amongst the clusters;
determine centers of the clusters as initial candidate sink locations for the clock buffers; and
determine new clusters of the loads based on the initial candidate sink locations for the clock buffers; and
determine centers of the new clusters as optimized initial candidate sink locations for the clock buffers.

17. The apparatus of claim 16, wherein the computer usable program code configured to determine the clusters of loads comprises the computer usable program code configured to:
divide the clock distribution network into two clusters with similar load distribution;
repeatedly divide each of the two clusters into clusters with similar load distribution until the number of clusters is greater than or equal to the number of clock buffers; and
determine the number of clusters equal to the number of clock buffers.

18. The apparatus of claim 16, wherein the computer usable program code configured to determine the clusters of loads comprises the computer usable program code configured to:
determine non-uniform load points in the clock distribution network, wherein a non-uniform load point is a point in the clock distribution network which has one or more loads in its neighborhood on a next level of the clock distribution network;
form a number of clusters equal to the number of non-uniform load points; and
merge the clusters to form a number of clusters equal to the number of clock buffers.

19. The apparatus of claim 16, wherein the computer usable program code configured to determine the clusters of loads comprises the computer usable program code configured to:
determine non-uniform load points in the clock distribution network, wherein a non-uniform load point is a point in the clock distribution network which has one or more loads in its neighborhood on a next level of the clock distribution network;
determine a number of points equal to the number of clock buffers from the non-uniform load points using the metric k-center technique; and
associate loads with the points to form a number of clusters equal to the number of clock buffers.

20. The apparatus of claim 16, wherein the computer usable program code configured to determine the clusters of loads comprises the computer usable program code configured to:
determine non-uniform load points in the clock distribution network, wherein a non-uniform load point is a point in the clock distribution network which has one or more loads in its neighborhood on a next level of the clock distribution network; and
determine a number of clusters equal to the number of clock buffers using the k-means clustering technique.
